(19) United States
(12) Patent Application Publication
(10) Pub. No.: US 2020/0376824 A1
(43) Pub. Date: Dec. 3, 2020

(54) Assembly for and Method of Automated Manufacture of Multi-Layer Foam Laminate Mattresses

(71) Applicant: Sealy Technology, LLC, Trinity, NC (US)

(72) Inventors: Victor Covone, Phoenix, AZ (US); Micah A. Kaufman, Lexington, KY (US); Lisa Nowak, Medina, OH (US); Ronald Buerkle, Plainfield, IN (US); Jeff Fillers, Duffield, VA (US)

(21) Appl. No.: 16/606,963

(22) PCT Filed: Apr. 25, 2018
(86) PCT No.: PCT/US2018/029370

§ 371 Date: Oct. 21, 2019

Related U.S. Application Data
(60) Provisional application No. 62/491,465, filed on Apr. 28, 2017.

(51) Int. Cl. B32B 37/12; B05B 13/04; B32B 5/18; B32B 5/32; B32B 27/40

(52) U.S. Cl. CPC B32B 37/1284; B05B 13/0473; B32B 5/18; B32B 5/32; B32B 27/40; B32B 2266/06; B32B 2250/02; B32B 2250/03; B32B 2250/22; B32B 2250/24; B32B 2266/0278; B32B 2479/00

(57) ABSTRACT

Present embodiments relate to assemblies for and methods of manufacturing laminate foam mattresses including, but not limited to, cushions and other mattress. More specifically, the embodiments pertain to, without limitation, a glue bridge assembly used to form laminate mattresses and the methods of using the glue bridge assembly.

### CLAIM TO PRIORITY

This PCT patent application claims priority to and benefit of, under 35 U.S.C. § 119(e), U.S. Provisional Patent Application Ser. No. 62/491,465, filed Apr. 28, 2017 and titled “Assembly For And Method Of Automated Manufacture Of Multi-layer Foam Laminate Mattresses”, all of which is incorporated by reference herein.

### BACKGROUND

### Field of the Invention

Present embodiments relate to assemblies for and methods of manufacturing laminate foam mattresses including, but not limited to, cushions and other mattress. More specifically, the embodiments pertain to, without limitation, a glue bridge assembly used to form laminate mattresses and the methods of using the glue bridge assembly.

### Description of the Related Art

Mattresses are typically used in a bed to support a user's body or a portion thereof, (e.g., head, shoulders, legs, etc.) while the user is at rest. Some mattresses include multiple foam layers. Such mattress assemblies can be heavy and costly to manufacture. Conventional mattress assemblies can also differ in firmness and comfort feel by adjusting the number, thickness and composition of the constituent foam layers.

Multi-layer foam mattresses, also referred to herein as laminate mattresses, of the prior art are designed to provide adequate support, without the use of wire springs, and pressure-relieving conformity, particularly in the top layer. Typically, the first or top foam layer that is in contact with the user may be made of visco-elastic foam, i.e., foam which is both viscous in order to conform under pressure, and elastic in order to return to its uncompressed state. Visco-elastic foam is sensitive to body heat such that the material conforms to the user's body, providing a more comfortable sleep surface. Multiple layer foam mattresses come in a variety of forms as the type of material, the thickness of each layer and the density of each layer can be varied to provide a mattress with different support characteristics.

Foams have numerous characteristics, including density and firmness, which contribute to the “feel” of the mattress. Density refers to the weight per unit volume amount of gas-containing cells within a foam matrix. Firmness refers to the rigidity or spring rate of the foam. Therefore, by varying the density and firmness of a foam, one may provide a mattress having a different “feel.” Further, by combining layers of different types of foams, a multitude of different mattresses possessing a broad spectrum of “feel” may be produced.

Solid foams, included closed cell and open cell (reticulated) structures, provide lightweight cellular engineering materials for weight bearing and distribution (pressure distribution) and energy absorption. In general, open-cell-structured foams have pores that are interconnected in a network. The interstitial spaces of open-cell foams can be filled with gas, liquid or solid material. The density of foam is determined in part by both the amount of structural material which forms the cells, such as polyurethane, polyethylene or latex, and the volume or size of the cells.

Closed-cell foams generally do not have interconnected pores, generally have relatively higher compressive strength due to the closed cell bubble structures, and are relatively denser. The closed-cell structure foams have higher dimensional stability, low moisture absorption coefficients, and higher strength compared to open-cell-structured foams. The closed cells can be filled with gases to provide improved insulation, or with other materials to alter the physical properties of the foam. All types of foam have been widely used as core material in sandwich structure composite materials.

A special class of closed-cell foams is known as syntactic foam, which contains hollow particles embedded in a matrix material. The particles can be made from several materials, including glass, ceramic, and polymers. The advantage of syntactic foams is that they have a very high strength-to-weight ratio, making them ideal materials for many applications. One particular syntactic foam uses shape memory polymer which enables the foam to take on the characteristics of shape memory resins and composite materials with hysteresis properties which enable it to be reshaped repeatedly when heated above a certain temperature and cooled.

Shape memory foams have been increasingly used in bedding products such as mattresses and pillows. A significant performance issue and problem with visco-elastic and latex foam mattresses is the concentration of heat which accumulates during use as a result of the high density and low thermal conductivity of the foam material.

Many of the foregoing foam laminates are formed by use of glue or adhesive or join the layers of foam together to form the cushion or mattress or subassemblies thereof. In certain methods of assembly, glue may be manually applied. However such manual application may result in inappropriate amount of glue and/or compression and glue applied in the wrong places. Further, problems may result for the workers applying the glue manually. For example, ergonomic problems associated with the reaching as well as acute (burn) risks due to the temperature of the adhesive.

In addition to the risks to workers and problems associate with manual glue steps, problems may be associated with the foam placement. In manual operations, the unassisted foam panel placement allows for misalignments of the foam layers. These misalignments also have to be corrected by stretching or compressing materials which may additionally create uneven edges and inconsistent feel across the bed.

Further, timing of the manual lamination processes can sometimes surpass glue open time specifications. As a result, bond performance may be jeopardized. Due to variation in the parts (and some parts which may be out of spec for any of the preceding reasons, product experience, aesthetic and functional.

It would be desirable to overcome these and other issues associated with the manual construction of laminate foam layer mattresses in order to provide an improved product and improve the construction process.

The information included in this Background section of the specification, including any references cited herein and any description or discussion thereof, is included for technical reference purposes only and is not to be regarded subject matter by which the scope of the invention is to be bound.

### SUMMARY

The present application discloses one or more of the features recited in the appended claims and/or the following features which alone or in any combination, may comprise patentable subject matter.

The multi-layer foam laminate mattresses of the present disclosure may be formed by use of a novel glue bridge assembly and a method associated with the glue bridge assembly, which provides unexpected and improved characteristics for the laminate. The glue bridge assembly allows for discrete laminate formation or continuous laminate formation.

According to some embodiments, a method of applying adhesive to one or more foam layers to form a laminate mattress comprises the steps of conveying a first foam layer under a glue dispenser bridge, identifying a size of the first foam layer, determining a plurality of process characteristics for at least one of the first foam layer and at least a second foam layer, applying a predetermined amount of glue to the first foam layer in at least one of a predetermined density or predetermined pattern, applying a second foam layer on to the first foam layer, and compressing the first foam layer and the second foam layer.

Optionally, any of the following optional embodiments may be utilized alone with the previous embodiment or in combination with other optional embodiments and in combination with the previous embodiment. The method may further comprise monitoring flow meters to confirm an amount of glue applied. The method may further comprise signaling when an amount of glue applied differs substantially from the predetermined amount of the glue. The monitoring being by at least one of a flow meter or software. The method may further comprise utilizing an alignment conveyor in applying the second foam substrate. The method may further comprise applying a third foam substrate. The method may further comprise trimming the foam substrates to a desired size. The method may further comprise moving the foam substrate in at least one direction beneath the glue dispenser bridge. The method may further comprise optimizing compression time during the method. The method may further comprise optimizing cycle time for manufacture of a mattress. The plurality of characteristics including at least two of: speed of movement of said glue dispenser bridge, speed of movement of foam layers, adhesive density, surface area of said layers, adhesive pattern, mattress size, surface area of said layers, adhesive type, compression time, and compression force.

A glue bridge assembly comprises a first support and a second support spaced apart and configured to allow a substrate to pass there through, a glue dispenser bridge extending between said supports, said glue dispenser bridge having a plurality of glue dispensers, the plurality of glue dispensers directed downwardly to apply glue to a first foam layer which is be configured to pass below the glue dispenser bridge on the substrate, a plurality of flow meters in flow communication with said plurality of glue dispensers, said flow meters creating a closed loop signal with a processor to confirm an amount of glue dispensed by said glue dispensers on said glue dispenser bridge.

Optionally, any of the following optional embodiments may be utilized alone with the previous embodiments or in combination with other optional embodiments and in combination with the previous embodiments. The foam substrate may be fed to the glue dispenser bridge in discrete form. The glue bridge assembly may further comprise a first side of the glue dispenser bridge and a second side of the glue dispenser bridge. The glue bridge assembly may further comprise a first alignment conveyor directing a first foam layer to the first side. The glue bridge assembly may further comprise a second alignment conveyor directing second foam layers to the second side. The substrate may move the first and second layers relative to the glue bridge. The glue bridge assembly may further comprise at least one glue machine to dispense glue through the flow meters to the glue dispensers. The glue bridge assembly may further comprise a press downstream of the glue dispenser bridge. The foam layer may be fed to the glue dispenser bridge in continuous form. The glue bridge assembly may further comprise a press which is defined by at least one heated roller. The glue bridge assembly may further comprise a trim station where a laminate of the layers is cut in at least one direction.

All of the above outlined features are to be understood as exemplary only and many more features and objectives of the assembly for and method of manufacture of multi-layer foam laminate mattresses may be gleaned from the disclosure herein. Therefore, no limiting interpretation of this summary is to be understood without further reading of the entire specification, claims and drawings, included herewith.

### BRIEF DESCRIPTION OF THE DRAWINGS

In order that the embodiments may be better understood, the assembly for and method of automated manufacture of multi-layer foam laminate mattresses will now be described by way of examples. These embodiments are not to limit the scope of the claims as other embodiments of the multi-layer foam laminate mattress will become apparent to one having ordinary skill in the art upon reading the instant description. Non-limiting examples of the present embodiments are shown in figures wherein:

FIG. 1 is a partially sectioned perspective view of a first illustrative embodiment of a multi-layer foam laminate mattress;

FIG. 2 is a partially sectioned perspective view of a second illustrative embodiment of a multi-layer foam laminate mattress;

FIG. 3 is an exploded perspective view of a third illustrative embodiment of a multi-layer foam laminate mattress;

FIG. 4 is a section view of a fourth illustrative embodiment of a multi-layer foam laminate mattress;

FIG. 5 is a schematic view of an embodiment of an automated assembly and method of manufacture of a multi-layer foam laminate mattress;

FIG. 6 is a perspective view of the exemplary assembly of FIG. 5; portions of which are shown schematically;

FIG. 7 is an alternate embodiment of the assembly of FIG. 6;

FIG. 8 is a view of the embodiment of FIG. 7 in a different position;

FIG. 9 is a process flow chart of steps of an illustrative method; and,

FIG. 10 is a schematic view of an alternate continuous manufacturing assembly.

### DETAILED DESCRIPTION

It is to be understood that the assembly for and method of automated manufacture of multi-layer foam laminate mattresses is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The embodiments are being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present embodiments, and do not alone indicate or imply that the device or element referred to must have a particular orientation. In addition, terms such as “first”, “second”, and “third” are used herein and in the appended claims for purposes of description and are not intended to indicate or imply relative importance or significance.

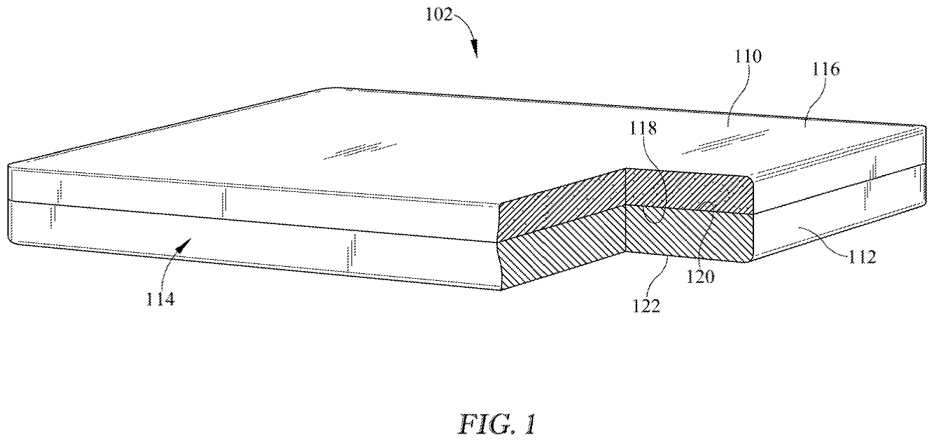

Referring now in detail to the drawings, wherein like numerals indicate like elements throughout several views, there are shown in FIGS. 1-10 various embodiments of an assembly for and methods of automated manufacture of multi-layer foam mattresses. The instant embodiments provide assemblies and methods of discretely assembling laminates or continuous assembly of mattress foam layers. The assembly also provides for determination of various characteristics of each mattress which optimizes the process.

Referring now to FIG. 1, a partially sectioned perspective view of an illustrative embodiment is provided of a multi-layer foam laminate mattress 102. The term mattress and the form of the mattress may comprise, for non-limiting example, various types of supports including bedding and/or cushions for chairs and furniture, pillows, padding for medical devices and equipment (e.g., wheelchair seat pads, wheelchair padding, medical pads, hospital gurney pads, operating table pads, positioning pads), padding for furniture (e.g., upholstery padding, furniture cushions, furniture pads), padding for athletic equipment and devices (e.g., athletic cushions, sports and athletic padding, gymnastic mats), padding for recreational equipment and devices (e.g., camping and sleeping mats), padding for apparel (e.g., bra straps, shoulder pads, shoe linings, boot linings), padding for household goods (e.g., anti-fatigue mats, mattress pads, mattress covers, mattress “toppers,” the pillow-top portion of pillow-top mattresses, pillows, and the like); padding accessories (e.g., briefcase shoulder straps, computer carrying cases, purses, gloves, and the like), pet beds, and the like. Thus any of these types of structures, and others, may fall within the scope of the term mattress. The mattress 102 may include at least two layers of foam, or substrates, which are laminated together. The mattress may be all foam or may have foam and other material layers.

The mattress 102, according to an illustrative embodiment, comprises two substrates of material: a top layer 110 comprising, for example open-celled non-reticulated visco-elastic foam (sometimes referred to as “memory foam” or “low resilience foam”) and a bottom layer 112 comprising reticulated non-visco-elastic foam. In some embodiments, the top layer 110 may be a comfort layer or may be a topper. In some embodiments, the bottom layer 112 may be a support layer. In some embodiments, the top layer 110 can rest upon the bottom layer 112 without being secured thereto. However, in other embodiments, and as related to the instant embodiments, the top and bottom layers 110, 112 are secured to one another by adhesive or cohesive bonding material, by being bonded together during formation of the top and bottom layers 110, 112, by tape, hook and loop fastener material, conventional fasteners, stitches extending at least partially through the top and bottom layers 110, 112, or in any other suitable manner. Each of the layers 110, 112 or the mattress 102 as a whole may have a sidewall 114 defining a thickness of the layers or mattress as a whole. Moreover, each of the layers 110, 112 may be defined by one or more layers of foam.

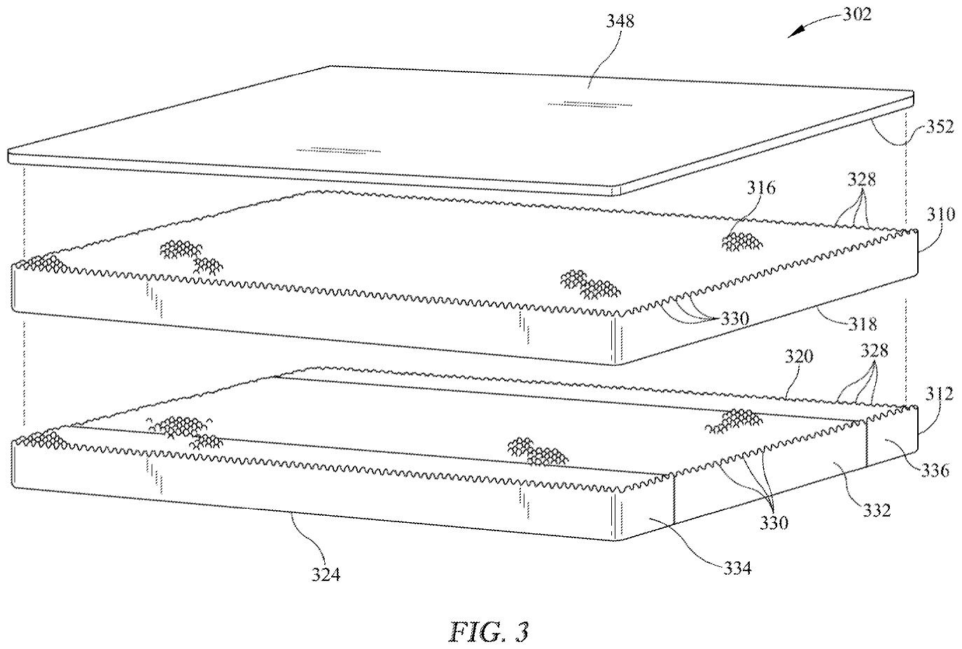

Each of the top and bottom layers 110, 112 can be substantially flat bodies having substantially planar top and bottom surfaces 116, 118, 120, 122. However, in other embodiments, one or more of the top and bottom surfaces 116, 118, 120, 122 of either or both top and bottom layers 110, 112 can be non-planar, including without limitation, surfaces having ribs, bumps, and other protrusions of any shape and size, surfaces having grooves, dimples, and other apertures that extend partially through, nearly completely or entirely through the respective layers 110, 112, and the like, as shown in FIG. 3. Also, depending at least in part upon the application of the mattress 102 (i.e., the product defined by the mattress 102 or in which the mattress 102 is employed), either or both of the top and bottom layers 110, 112 can have shapes that are not flat. By way of example only, either or both layers 110, 112 can be generally wedge-shaped, can have a concave or convex cross-sectional shape, can have a combination of convex and concave shapes, can have a stepped, faceted, or other shape, can have a complex or irregular shape, and/or can have any other shape desired. Such shapes may for example be associated with pillows or cushions, for non-limiting example.

In some embodiments, the top layer 110 provides a relatively soft and comfortable surface for a user's body. Coupled with the slow recovery characteristic of the visco-elastic foam, the top layer 110 can also conform to a user's body, thereby distributing the force applied by the user's body upon the top layer 110. In some embodiments, the top layer 110 has a hardness of at least about 30 N and no greater than about 175 N for desirable softness and body-conforming qualities. These ranges are merely illustrative and should not be considered limiting as other ranges may be utilized.

The top layer 110 can also have a density providing a relatively high degree of material durability. The density of the foam in the top layer 110 can also impact other characteristics of the foam, such as the manner in which the top layer 110 responds to pressure, and the feel of the foam. In some embodiments, the top layer 110 has a density of no less than about 30 kg/m³ and no greater than about 150 kg/m³. This range is also illustrative and non-limiting as other ranges may be utilized.

The visco-elastic foam of the top layer 110 can be selected for responsiveness to any range of temperatures. However, in some embodiments, a temperature responsiveness in a range of a user's body temperatures (or in a range of temperatures to which the mattress 102 is exposed by contact or proximity to a user's body resting thereon) can provide significant advantages.

As used herein and in the appended claims, a material is considered “responsive” to temperature changes if the material exhibits a change in hardness of at least 10% measured by International Organization for Standardization (ISO) Standard 3386 through the range of temperatures between 10 and 30 degrees Celsius.

The top layer 110 of the illustrated mattress 102 may comprise a cellular structure of flexible visco-elastic polyurethane foam in which the walls of the individual cells are substantially intact. In some embodiments, the bottom layer 112, comprising reticulated foam, can reduce heat in the top layer 110, due at least in part to the cellular structure of the foam of the bottom layer 112. For example, the cells of the foam of the bottom layer 112 are essentially skeletal structures in which many (if not substantially all) of the cell walls separating one cell from another do not exist. In other words, the cells are defined by a plurality of supports or “windows” and by no cell walls, substantially no cell walls, or by a substantially reduced number of cell walls. Such a cellular foam structure is sometimes referred to as “reticulated” foam. In some embodiments, a foam is considered “reticulated” if at least 50% of the walls defining the cells of the foam do not exist (i.e., have been removed or were never allowed to form during the manufacturing process of the foam).

Also, in some embodiments it is desirable that the bottom layer 112 of reticulated non-visco-elastic foam be capable of providing some degree of support that is substantially independent of temperatures experienced by the top layer 110 when supporting a user's body (i.e., independent of a user's body heat). Therefore, the bottom layer 112 can comprise reticulated non-visco-elastic foam that is substantially insensitive to temperature changes within a range of between about 10° C. and about 35° C. As used herein, a material is “substantially insensitive” to temperature changes if the material exhibits a change in hardness of less than 10% measured by ISO Standard 3386 through the range of temperatures between 10 and 30 degrees Celsius. Other temperature ranges are also capable of use and therefore the temperature range should only be considered illustrative and not limiting.

By virtue of the skeletal cellular structure of the bottom layer 112, heat in the top layer 110 can be transferred away from the top layer 110, thereby helping to keep a relatively low temperature in the top layer 110. Also, the reticulated non-visco-elastic foam of the bottom layer 112 can enable significantly higher airflow into, out of, and through the bottom layer 112—a characteristic of the bottom layer 112 that can also help to keep a relatively low temperature in the top layer 110.

Like the top layer 110, the bottom layer 112 can have a density providing a relatively high degree of material durability. Also, the density of the foam in the bottom layer 112 can also impact other characteristics of the foam, such as the manner in which the bottom layer 112 responds to pressure, and the feel of the foam. In some embodiments, the bottom layer 112 has a density of no less than about 20 kg/m³ and no greater than about 80 kg/m³. In other embodiments, a bottom layer 112 having a density of at least about 25 kg/m³ and no greater than about 60 kg/m³ is utilized. In still other embodiments, a bottom layer 112 having a density of at least about 30 kg/m³ and no greater than about 40 kg/m3 is utilized.

The layers may be affixed by any suitable means known in the art. Layers 110, 112 may be sprayed-on, injection molded, extruded, coextruded, laminated, and the like. In several embodiments, layers may be stapled, tacked, welded, laminated, mechanically affixed via friction or interference fit, adhered via an adhesive, a glue, a cement, or other material with adhesive properties, stitched, affixed via hook and loop fastener, a zipper, a Dennison-style tag, snaps, and/or other reversible means, and combinations thereof. For purposes of present embodiments, various layers may be joined with adhesives including glues, cements and other materials with adhesive properties.

The layers 110, 112 may be of any thickness. For example, in several embodiments, the component layer may be less than or about ½ inch, less than or about 1 inch, less than or about 2 inches, less than or about 3 inches, less than or about 4 inches, less than or about 5 inches, less than or about 6 inches, less than or about 8 inches, or less than or about 12 inches, and all thicknesses in between. Component layers may also be of varying widths and lengths that are not necessarily tied to the size of the component. For example, a mattress may include a first layer with a first width and a second layer with a second width, where the first width is wider or narrower than the second width. When a layer is wider than the component, it may be folded in upon itself or folded upwardly or downwardly along the side of the component to form a portion of a sidewall of the component. Similar variability with respect to layer length is also possible.

Layers as described herein, including layers 110, 112, may comprise, but are not limited to, foams of the type previously described, in addition to, or alternatively, a fabric, a natural fiber, a synthetic fiber, a ticking layer, a quilt layer, a thread layer, a film, a spring unit, a foam, a gel, a gel infused foam, gel memory foam, a multi-gel foam, a high thermal conductivity foam, a woven layer, a nonwoven layer, a fire-resistant layer, a non-skid layer, and combinations thereof. A component core layer may be any mattress core construction including, but not limited to, a foam core, a gel foam core, a latex core, an inner spring layer, a layer of individually wrapped or encased coils, an inflated air system, or a liquid system, e.g., water.

In another embodiments, a layer may further include an adhesive. In some embodiments, the adhesive may be located at interfaces between the layers 110, 112. Adhesives that may be used in the present disclosure include any adherent materials or fasteners known in the art. Specific examples of adhesives include hot melt, water-based, and pressure-sensitive adhesives, fire-resistant adhesives, and mixtures thereof. Further, a layer and/or an adhesive may further include a silica, a metallic layer, a plastic, such as an acrylic, a modacrylic, a polyolefin, a latex, a polyurethane, and combinations and/or blends thereof. In addition, a layer may further include biocides, preservatives, odor blocking agents, scents, pigments, dyes, stain guards, antistatic agents, anti-soiling agents, water-proofing agents, moisture wicking agents, and the like, as are known in the art.

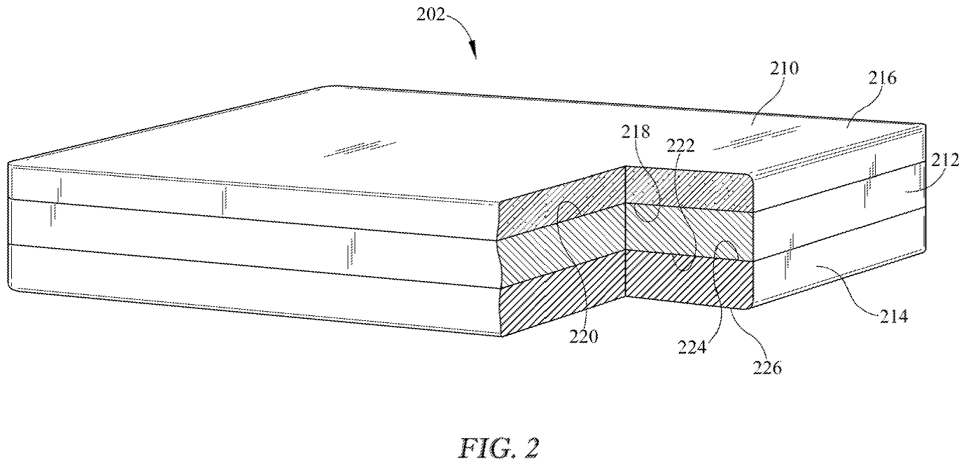

With reference now to FIG. 2, an additional illustrative embodiment is provided to show that additional layers may be utilized to define the mattress. In the illustrative embodiment, a mattress 202 may comprise a top layer 210 comprising, for non-limiting example, open-celled non-reticulated visco-elastic foam and an underlying layer 212 comprising reticulated non-visco-elastic foam. In some embodiments, the mattress 202 can therefore provide the desirable softness, body-conforming, ventilation, and heat transfer properties described above. As compared to the embodiment of FIG. 1, the mattress 202 may further comprise a bottom layer 214 beneath the layer of reticulated non-visco-elastic foam layer 212. Therefore, the layer 212 of reticulated non-visco-elastic foam may be a middle layer 212 located between the top and bottom layers 210, 214 of the mattress 202.

The bottom layer 214 of the mattress 202 may comprises a cellular structure of flexible polyurethane foam. In some embodiments, the middle layer 212 can rest upon the bottom layer 214 without being secured thereto. However, in other embodiments, and as related to the instant embodiments, the middle and bottom layers 212, 214 may be secured to one another in any of the manners described above with reference to the possible types of connection between the top and bottom layers 110, 112 in the illustrated embodiment of FIG. 1. In this regard, it should be noted that absent description herein to the contrary, any adjacent layers of material in any of the mattress embodiments disclosed herein can be permanently or releasably secured to one another in any of the manners described above (with reference to the possible types of connection between the top and bottom layers 110, 112 in the illustrated embodiment of FIG. 1), or can be unconnected.

Each of the top, middle, and bottom layers 210, 212, 214 can be substantially flat bodies having substantially planar top and bottom surfaces 216, 218, 220, 222, 224, 226 as shown in FIG. 2. However, any or all of the top and bottom surfaces can have any of the non-planar shapes described above in connection with the surfaces 116, 118, 120, 122 in the illustrated embodiment of FIG. 1. Also, depending at least in part upon the application of the mattress 202 (i.e., the product defined by the mattress 202 or in which the mattress 202 is employed), either or both of the top, middle, and bottom layers 210, 212, 214 can have a shape that is not flat, including any of the shapes described above in connection with the illustrated embodiment of FIG. 1.

Absent description herein to the contrary, any or all of the layers of material in any of the mattress embodiments disclosed herein can be substantially flat, or can have any shape that is not flat, including any of the shapes described above in connection with the illustrated embodiment of FIG. 1. Also absent description herein to the contrary, the surfaces of either or both opposite faces of any or all of the layers of material in any of the mattress embodiments disclosed herein can be substantially planar, or can instead have any of the non-planar shapes described above in connection with the surfaces 116, 118, 120, 122 in the illustrated embodiment.

In some embodiments, the bottom layer 214 is a supportive layer providing a relatively stiff substrate upon which the top and middle layers 210, 212 lie, while still having a degree of deformability to provide user comfort (to the extent that the user's weight affects the shape of the bottom layer 214). Therefore, the bottom layer 214 can comprise a foam having a relatively high resilience capable of providing significant support to the top and middle layers 210, 212. The bottom layer 214 can have a resilience greater than that of the other layers 210, 212 in the mattress 202. In some embodiments, the bottom layer 214 has a hardness of at least about 50 N and no greater than about 300 N for a desirable degree of support and comfort. However, this range is merely illustrative and should not be considered limiting as various ranges may be utilized.

Depending at least in part upon the thickness and material properties of the top and middle layers 210, 212, in some embodiments the bottom layer 214 can be exposed to substantial body heat from a user resting upon the mattress 202. In such embodiments, the foam of the bottom layer 214 can be selected to be substantially insensitive to temperature changes (as defined above) within a range of between about 10° C. and about 35° C., thereby retaining the supportive properties desired for the bottom layer 214 throughout a range of body temperatures to which the bottom layer 214 may be exposed. However, other ranges may be utilized and therefore this should not be considered limiting.

Like the top and middle layers 210, 212, the bottom layer 214 can have a density providing a relatively high degree of material durability. Also, the density of the foam in the bottom layer 214 can also impact other characteristics of the foam, such as the manner in which the bottom layer 214 responds to pressure, and the feel of the foam. In some embodiments, the bottom layer 214 has a density of no less than about 20 kg/m³ and no greater than about 80 kg/m³. This range however is merely illustrative and should not be considered limiting.

The mattress 202 illustrated in FIG. 2 can have a bottom layer 214 that is at least as thick as the combination of the top and middle layers 210, 212, thereby providing substantial support for the top and middle layers 210, 212. In some embodiments, the bottom layer 214 may be at least about ⅔ of the combined thickness of the top and middle layers 210, 212. Also, in some embodiments, the bottom layer 214 is at least about half the combined thickness of the top and middle layers 210, 212. As with the previous embodiment, the bottom layer 214 may be a support layer and the layers 210, 212 may be comfort layers. However, various layers may define the comfort or support layers.

With reference now to FIG. 3, a further embodiment is depicted wherein the layers may have surfaces which are non-planar. This mattress 302 embodiment may comprise similar or same structure and properties as previous mattress embodiments: a top layer 310 comprising open-celled non-reticulated visco-elastic foam, beneath which lies a bottom layer 312 comprising a first portion 332 comprising reticulated non-visco-elastic foam flanked by second and third portions 334, 336 comprising relatively highly resilient flexible cellular foam. Thus, one difference may be lateral positions which define a layer. The first portion 332 can comprise reticulated non-visco-elastic foam having the same properties described above with reference to the bottom layer 112 of the mattress 102 illustrated in FIG. 1. The second and third portions 334, 336 can comprise relatively highly resilient flexible cellular foam having the same properties described above with reference to the bottom layer 214 of the mattress 202 illustrated in FIG. 2. Also, the portions 332, 334, 336 can have any of the shapes and arrangements described above.

If desired, the bottom surface 318 of the top layer 310 and/or the top surface 320 of the bottom layer 312 can have a non-planar shape defining a plurality of passages 330 between the top and bottom layers 310, 312. In the illustrated embodiment of FIG. 3, for example, passages 330 are defined between a substantially planar bottom surface 318 of the top layer 310 and a non-planar top surface 320 of the bottom layer 312. The non-planar shape of the top surface 320 of the bottom layer 312 can take any of the forms. Alternatively, the bottom surface of layer 310 may be non-planar and the top surface of layer 312 may be planar. In some embodiments, the non-planar surface may be referred to as egg-crate shaped. However, other patterns may be used.

The passages 330 between the bottom surface 318 of the top layer 310 and the top surface 320 of the bottom layer 312 can provide enhanced ventilation and/or heat dissipation of the mattress 302. The passages 330 can be particularly useful in reducing heat in regions of the mattress 302. The passages 330 can supplement the ability of the reticulated non-visco-elastic foam of the first portion 332 to dissipate heat between the second and third portions 334, 336 of relatively highly resilient flexible cellular foam and the top layer 310 of non-reticulated visco-elastic foam.

Although the first portion 332 of the bottom layer 312 illustrated in FIG. 3 comprises reticulated non-visco-elastic foam, and the second and third portions 334, 336 of the bottom layer 312 comprise a relatively highly resilient flexible cellular foam, the material of the first portion 332 and the material of the second and third portions 334, 336 can be reversed in other embodiments.

With continued reference to the illustrated embodiment of FIG. 3, the first and second layers 310, 312 of the mattress 302 can have a topper 348 comprising, for example, reticulated non-visco-elastic foam. The reticulated non-visco-elastic foam of the topper 348 can have the same properties as described above with reference to the bottom layer 112 of the mattress 102 illustrated in FIG. 1. Also, the reticulated non-visco-elastic foam of the topper 348 can cover any portion of the first and second layers 310, 312. For example, the topper 348 may cover substantially the entire top surface 316 of the top layer 310. In other embodiments, the topper 348 can also or instead cover any portion or all of the sides and ends of the first and second layers 310, 312, and/or can underlie any portion or all of the bottom surface 324 of the bottom layer 312. In some embodiments, the topper 348 substantially entirely surrounds the first and second layers 310, 312.

The foam topper 348 can be selected to provide a heightened degree of fire resistance to the mattress 302, and in some countries and/or localities can be utilized to meet fire codes calling for such fire resistance. Although other materials capable of meeting such fire code requirements can be employed, the use of reticulated non-visco-elastic foam can provide improved ventilation for the surface(s) of the first and/or second layers 310, 312 covered by the reticulated non-visco-elastic foam topper 348. As described above, reticulated non-visco-elastic foam can reduce the amount of heat in adjacent areas of a mattress, based at least in part upon the skeletal cellular structure of the reticulated foam. Therefore, in some embodiments, the reticulated non-visco-elastic foam topper 348 can provide a degree of fire resistance while also dissipating heat from the adjacent first and/or second layers 310, 312 covered by the reticulated foam topper 348 in use of the mattress 302.

With continued reference to the embodiment of FIG. 3, the visco-elastic nature of the top layer 310 can provide a relatively comfortable substrate for a user's body, can at least partially conform to the user's body to distribute force applied thereby, and can be selected for responsiveness to a range of temperatures generated by the body heat of a user. In some embodiments, the reticulated foam topper 348 (if employed) has a maximum thickness through which these properties can still be exhibited. Although the desirable tactile feel of the visco-elastic first layer 310 can be blocked in some embodiments by the reticulated non-visco-elastic foam topper 348, the other desirable properties of the visco-elastic material of the first layer 310 are still experienced through a sufficiently thin reticulated non-visco-elastic foam topper 348. In some embodiments, the reticulated non-visco-elastic foam topper 348 has a maximum thickness of about 1 cm. In other embodiments, the reticulated non-visco-elastic foam cover 348 has a maximum thickness of about 2 cm. In still other embodiments, the reticulated non-visco-elastic foam topper 348 has a maximum thickness of about 5 cm.

As also shown in FIG. 3, the top surface 316 of the top layer 310 can have a non-planar shape defining a plurality of passages 330 between the reticulated non-visco-elastic foam topper 348 and the top layer 310. In other embodiments, the passages 330 can be defined between a non-planar bottom surface 352 of the reticulated non-visco-elastic foam topper 348 and a substantially planar top surface 316 of the top layer 310 and/or between a non-planar bottom surface 352 of the reticulated non-visco-elastic foam cover 348 and a non-planar top surface 316 of the top layer 310. Enhanced user comfort, ventilation, and/or heat dissipation can be achieved in some embodiments by such passages 330.

The non-planar shape of the top surface 316 illustrated in FIG. 3 (and/or of the bottom surface 352 of the reticulated non-visco-elastic foam topper 348) can take any of the forms described above and can be defined by a plurality of protrusions 328 and/or a plurality of apertures as also described above.

The passages 330 between the bottom surface 352 of the reticulated non-visco-elastic foam topper 348 and the top surface 316 of the top layer 310 can provide a degree of ventilation and/or enhanced heat dissipation for the mattress 302. These passages 330 can be particularly useful in reducing heat in regions of the mattress 302. These passages 330 can also supplement the ability of the reticulated non-visco-elastic foam of the topper 348 to dissipate heat between the topper 348 and the top layer 310.

The reticulated non-visco-elastic foam topper 348 illustrated in FIG. 3 is utilized in conjunction with a top layer 310 comprising non-reticulated visco-elastic foam, and a bottom layer 312 comprising a first portion 332 of reticulated non-visco-elastic foam flanked by second and third portions 334, 336 of relatively highly resilient flexible cellular foam as described above. However, it should be noted that the reticulated non-visco-elastic foam topper 348 (and the alternative embodiments of the reticulated non-visco-elastic foam topper 348 described above) can be utilized to cover any or all surfaces of any of the mattresses described and/or illustrated herein. Many variations may be formed.

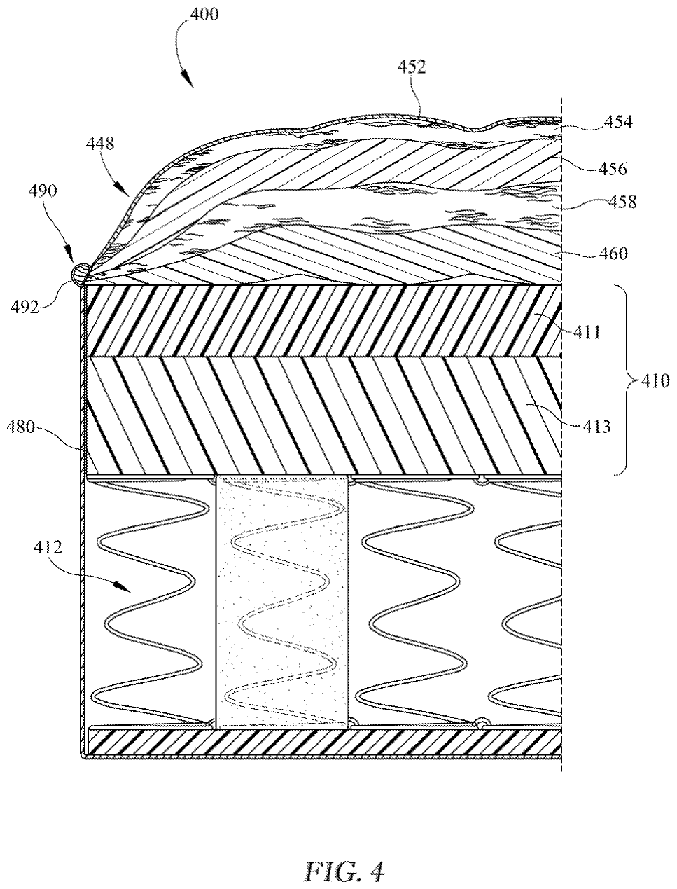

Referring now to FIG. 4, a further embodiment is shown in section view depicting a mattress 400 having a construction comprising additional layers which may comprise one or more layers of foam as well as one illustrative but non-limiting example of a topper 448. Additionally, this embodiment provides that one or more layers may be formed of materials other than foam. The representative mattress 400 comprises a core or bottom layer 412. The core 412 may be of any construction, such as an array of interconnected steel wire coiled springs (innerspring) as shown, wire coil springs contained in fabric material (pocketed coils) also shown with stippling, one or more pieces of foam (foam core) as previously described, or any combinations thereof and any other support or reflexive structures or components.

On the sleep surface side or sides of the bottom layer or core 412 are provided one or more upper or comfort layers 410, which are most commonly one or more layers of foam, with a first comfort layer 411 placed directly over the support surface area of the core 412, and additional comfort layers, such as layer 413 placed in contact with the surface area of layer 411. Layers of materials other than foam may also be similarly incorporated into the comfort layers 410 of the mattress construction.

The mattress core 412 and comfort layers 410, 411 may covered by upholstery 480, which extends around the vertical sides of the mattress in the form of a border and also a sheet material covering the underside. Upholstery 480 also extends over the topper 448, which may or may not be the same type or style material of the upholstery 480. The topper 448 may be attached to the border upholstery 480 along a seam, generally indicated at 490, the construction of which may further include a tape edge 492 which encapsulates the adjoining edges of the upholstery material. This is referred to as the “tape edge” or “tape edge seam” may be the primary or sole attachment of the topper 448 to the remainder of the mattress. Alternatively, the topper 448 may be adhered to the top comfort layers 410, 411 in a manner described further herein.

The topper 448 may comprise one or more layers of topped material or mattress topper layers or mattress topper internal layers which may include foam, fibers, cotton, wool, feathers or any other synthetic or natural materials in a generally co-planar arrangement as shown. For non-limiting example, immediately adjacent to the topper upholstery 452 is a first layer of topper material 454. Topper material 454 may be a fiber based material which can be adhered to substantially the entirety of the underside of topper upholstery 452 or otherwise arranged to provide support and loft to the topper upholstery 452, and which also preferably includes, is made of or treated with a flame resistant or fire retardant material as known in the art. Topper layer 454 thus serves as a flame resistant barrier which will withstand the standardized flame burn test for mattresses over the entire surface area of the topper 448. The fire resistant material for topper layer 454 may include flame and heat resistant materials such as fiber mats, woven or nonwoven fabrics, knitted fabrics, films, laminates, and flexible composites or combinations thereof. Fibers of topper layer 454 can be formed into a batt or fabric web and stitch-bonded using the appropriate yarn to form a fire resistant layer. Flame and heat-resistant fibers known in the art include boron, basalt, carbon, glass, ceramic, graphite, aramid polymers, polytetrafluoroethylene (PTFE), polyimide, phenolformaldehyde, polybis-imidazole, polyvinylidene chloride, polysulfide, melamine, silicon carbide, and blends thereof.

A topper material 456 is in this embodiment a layer of foam material or the like which also extends over substantially the entirety of the topper 448 and one or more top layers 410 which is adjacent to or immediately adjacent to topper layer 454. Another topper layer 460 may also be made of foam, and can be of the same or different thickness than topper layer 456. Topper layer 460 as illustrated serves as a base layer of the topper 448 for primary contact with the top surface of the one or more top or comfort layers 410.

Between topper layers 456 and 460 may be an optional low shear layer 458 which is preferably in the form of a polymeric fiber layer in the form of a planar mat, either spun-bound or melt-bound wherein the fibers are interconnected but provide loft and spacing between opposing sides of the layer, and a high degree of motion by flexure of the fibers under shear or compression. The opposing sides of topper layer 458 are preferably in direct contact with the facing surfaces of topper layers 456 and 460 and, due to the dissimilarity of materials there is a relatively high coefficient of friction at those layer interfaces, greater than the internal sheer force of topper layer 458, so that topper layer 458 allows a greater degree of lateral displacement between topper layers 456 and 460 than a foam-to-foam interface. Topper layer 458 is also referred to herein as “low shear layer” and “low shear low shear insert layer”. Any suitable material which has an internal shear force measurement, internal friction or resistance to lateral deformation which is less than the adjacent layers of the topper 448 can serve as the low shear layer in accordance with the principles of the present invention.

The first fiber layer 458, which is placed between the first and second foam layers, can be made of non-fire retardant, non-woven, non-densified, high-loft fiber. The term “non-woven” is used in the textile industry to denote fabrics which are neither woven nor knitted. Non-woven fibers are engineered fibers that are typically manufactured by putting small fibers together in the form of a sheet or web, and then bonding them together by chemical, mechanical, heat or solvent treatment. The term “non-densified” refers to fibers which have not bonded to each other through the melting and re-solidification of bonding fibers. “High-loft” is a term given to a fiber structure that contains more air than fiber. In general, high-loft fibers retain more warmth. Foam-on-foam contact creates a significant amount of friction between two foam surfaces. As a load is applied to the mattress, the two foam layers move against one another in a shearing fashion, which over time, can wear away the surfaces of the foam which are in direct contact. The first fiber layer 458 operates to create a low coefficient of friction between the first and second foam layers. Therefore, the fiber layer must be made of material which has a slick or slippery surface. Such materials include, but are not limited to: polyester, polypropylene, nylon silk, acrylic, acetate and rayon. Eliminating friction between the first and second foam layers allows both foam layers to move independently against one another, creating a more comfortable, responsive mattress surface and also extending the life of the mattress. In some embodiments, the first fiber layer, which is sandwiched between the first and second foam layers, is made of 0.5 oz. 100% polyester fiber.

The representative mattress constructions are illustrated as “one-sided” type mattresses, with only one side of the core designed for use as a sleep surface, and the opposite underside as a mounting surface on which the mattress is supported by a foundation, frame, floor or other support structure. However, the topper constructions of the present embodiments can be incorporated into the construction of a two sided mattress in which both sides of the core are configured for use as a sleep surface. As illustrated, cores or bottom layers can be optionally configured with one or more layers of generally planar material, to provide a planar surface for mounting of the mattress on a support structure.

Still further, any of the layers of any of the preceding embodiments may be formed of a polymeric gel. One exemplary composite material can comprise a polymeric gel material that at least partially penetrates an open-cell foam material. For ease of illustration, the present composite materials may be referred to hereinafter as “gel-infused materials” or “gel-infused composite materials,” but it should be understood that the disclosure is not limited to any particular type of material. “Composite material,” as used herein, means a first material that at least partially penetrates a second material; the first and second material can be the same or different materials.

Further, in addition to any of the preceding layers, or others, being used in any of the preceding arrangements, or others, it should be understood that other features may be utilized. For example, an edge support maybe provided about the mattress for reinforcement and ability to utilize all of the upper surface of the bed, including the edges. Core supports may be used in the center of the bed, for example in the head to toe—longitudinal direction, in order to provide added support. Further, handles may be provided to ease the movement of the mattress for example from one room to another.

As set forth previously, it is desirable for a multitude of reasons to improve the process of forming mattresses to automate several of the capabilities and make possible in process optimization which is necessary for various types of mattresses each of which may include various types of foams. Characteristics of the process which may benefit from optimization include, but are not limited to, density of adhesive, automated determination of mattress size (surface area), consideration of type of foam layer, pattern of glue dispensing, glue pump control, adhesive type, and press time all for non-limiting example. The following description provides automation for a glue bridge assembly and a related method for improving the automated construction of mattresses which may include, but are not limited to, any of the preceding types of mattresses.

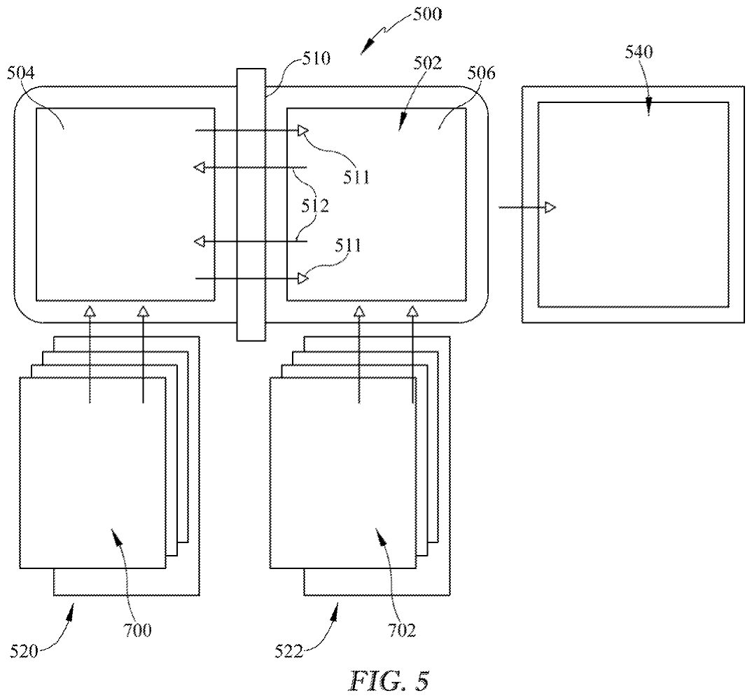

Referring now to FIG. 5, a schematic top view of one embodiment of a glue bridge assembly 500 is provided. The glue bridge assembly 500 includes a substrate 502 having a first side 504 and a second side 506 which are defined one either side of a glue dispenser bridge 510. The glue dispenser bridge 510 dispenses glue on to layers, generally 700, 702, for example any of the non-limiting examples which preceded in this application, so that at least one adjacent layer may be adhered to the first layer.

In the depicted embodiment, the one of more layers are laminated in discrete form. Discrete form is a non-continuous manner of laminating utilizing separate pieces or segments of the one or more layers of preselected size, which are laminated to form the mattress. In subsequent embodiments, an illustrative process and equipment are provided of a continuous form of manufacturing mattresses.

The substrate 502 provides a support for a first layer 700 on one side of the glue dispenser bridge 510 and passes beneath the glue dispenser bridge 510 to allow application of a glue in an automated fashion. Subsequently, a second layer 702 may be applied to the first layer 700. Either of the first or second foam layers may be defined by one of more layers, for example any layer or layers of the type previously described. The glue adhesive may be applied to the layer 702 and the process may continue until the laminate is of the desired construction.

In addition to support of the at least one foam layer, the substrate 502 may also provide for movement of the first one or more layers from the first side 504 to the second side 506, or vice-versa, in order to receive the second one or more layers. The movement may be automated by a structure which pushes the layers 700, 702 in the directions 511, 512. Alternatively, the substrate 502 may be defined by a belt which may be rotated in one or two directions. The belt may be disposed beneath the one or more foam layers and move the one or more layers with movement of the belt. In still further embodiments, the substrate may be formed by one or more rollers. One or more of the rollers may be driven to direct movement of the one or more foam layers between the first and second sides 504, 506. In still a further alternative embodiment, the substrate 502 may be fixed and the glue bridge may be movable relative thereto. Or, in a further embodiment, the glue dispenser bridge 510 may be movable as well as the substrate 502.

The glue dispenser bridge 510 and/or the substrate 502 may be movable and may be indexed and/or utilize a counter to aid in determining where to move, a distance moved or both. Additionally or alternatively, the counter or indexing mechanism may also provide a feedback loop information to a computer, processor or the like to confirm a location of either or both of the glue dispenser bridge 510 and/or the substrate 502. Thus a locating function may be an input to guide the glue bridge and/or used to confirm location as an output as well.

In the schematic view, arrows 511, 512 are shown pointing in two directions. In one direction, the arrows 511 indicate movement from the first side 504 to the second side 506. Alternatively arrows 512 indicate movement of the foam layer(s) from the second side 506 to the first side 504. This movement may be provided by movement of the glue dispenser bridge 510 relative to the substrate 502, or movement of the substrate 502 relative to the glue dispenser bridge 510, to direct the foam layer(s) thereon, or a combination thereof. As the glue dispenser bridge 510 moves relative to the one or more foam layer(s) on the substrate 502, or the one or more foam layers are moved relative to the glue dispenser bridge 510, adhesive is applied by the glue dispenser bridge 510 to an upper surface of the one or more layer(s) 700, 702.

Adjacent to the substrate 502 is a first alignment conveyor 520 and a second alignment conveyor 522. Each of the conveyors 520, 522 direct one or more layers, collectively 700, 702 to the first side 504 and second side 506, respectively. The conveyors 520, 522 may be represented by various structures including belt conveyors, roller conveyors, dynamic movers, static movers such as gravity feed structures, moveable sleds with or without any of the preceding features alone or in combination, and/or the like. All of these are non-limiting examples as this list in not exhaustive.

As this process starts a first layer 700 is placed on the substrate 502 and the glue dispenser bridge 510 applies a layer of adhesive to the layer 700, which may include, but is not limited to, foam. Subsequently, the second alignment conveyor 522 applies a second layer 702 to the first layer 700. While two alignment conveyors 520, 522 are shown, it should be understood that one or more conveyors may be used to feed layers to the substrate. For example, if one conveyor is used, all of the layers will be queued in a desired order thereon. However, in other embodiments, the number of conveyors will affect the order and location of the layers on each conveyor.

At one side of the substrate 502, may be a press 540 which is utilized to compress the first one or more layers 700 and the second one or more layer 702. The compression may occur once the first one or more layers 700 receives adhesive from the glue dispenser bridge 510 and the second one or more layers 702 are applied to the first one or more layers 700. The one or more layers 700, 702 may again be moved, and/or the glue dispenser bridge 510 moved, so that additional adhesive may be applied to the upper surface of the layer 702. A third layer may be applied from the first conveyor 520. This may continue for any number of layers as the mattress is built up in laminate form. The press 540 may be used for each layer after the second, or the press 540 may be used when the laminate mattress is completed.

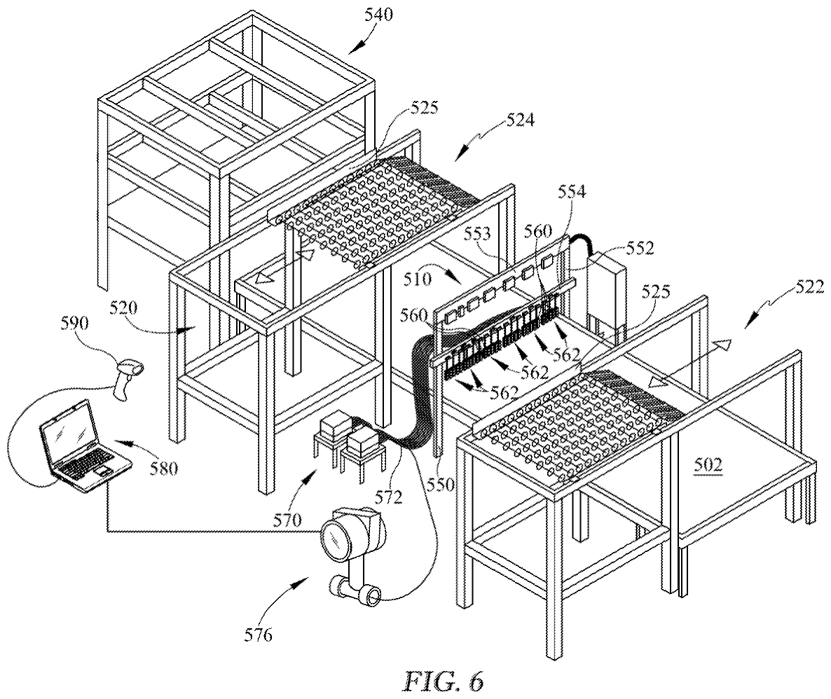

Referring now to FIG. 6, a perspective view of an illustrative glue dispenser bridge 510 is depicted. The glue dispenser bridge 510 has a first support and a second support 550, 552. A frame 553 may extend between the first and second supports 550, 552. A dispenser bridge 554 may also extend between the first and second supports 550, 552 and/or depend from the frame 553. The dispenser bridge 554 includes a plurality of glue dispensers, or nozzles, 560 which are located along the bridge 554 at multiple locations between the supports 550, 552. The dispenser bridge 554 may also be adjustable in a vertical direction toward or away from the substrate 502 to provide an additional dimension of adjustability and optimization of adhesive application.

The dispensers or nozzles 560 may be fixed or movable along the glue dispenser bridge 510. In the latter embodiment, the movable dispensers 560 move along the bridge 554 to provide an additional level of adjustability and precision to the adhesive dispersion density, the pattern of dispersion and the best location. In the depicted embodiment, the movement may be left and right. The movement may be automated with the dispensers 560 mounted on a belt, guide rod or other actuator. However, the dispensers may also be fixed in a position and/or may be manually adjustable, such as by loosening a fastener and allowing for positional adjustment before re-tightening. With the movement of the layers 700, 702 (FIG. 5) along the substrate 502, or alternatively movement of the glue dispenser bridge 510, two means of adjustability are provided which optimizes application of glue, adhesive or the like from the dispensers 560.

Additionally, the dispensers 560 may be defined by individually mounted dispensers or a head 562 including the plurality of dispensers 560 arranged in an array. The head 562 may include any number of dispensers 560 which create a desirable pattern. In addition, various other patterns may be created for example by using an on/off pattern. The instant embodiment provides a plurality of heads 562 each having a plurality of dispensers thereon. In the instant embodiment for non-limiting example, each head 562 includes five dispensers 560. The dispensers 560 may spray an adhesive in a preselected diameter, for non-limiting example 2″. The dispensers 560 may be arranged individually or in heads 562 so that the edge of each spray diameter touches or nearly touches the spray diameter of an adjacent dispenser 560. Thus, when all dispensers or nozzles 560 are on, a continuous line of adhesive may be provided extending across a layer of foam. Various patterns may be provided by location or movement of the dispensers 560, the dispersion pattern of each individual dispenser 560 and the adjustability of the dispensers 560 and/or heads 562.

Also shown schematically in this view is a glue reservoir 570 which is in fluid communication with a flow meter 576 and further in fluid communication with the plurality of dispensers 560. The glue reservoir 570 may be a machine which melts adhesive and pumps the melted adhesive from the reservoir 570 to the dispensers 560. One exemplary manufacturer of reservoir (or melters as they are also referred) is Nordson Corporation of Duluth, Ga. The reservoir 570 may deliver one or more streams of hot melt adhesive utilizing a pump such as, for non-limiting example, spur gear pumps and variable speed AC motor. The reservoirs 570 may be sized from 2 to about 100 liters but other volumes may be utilized. One or more streams may be delivered through the conduits to the dispensers 560.

The glue reservoir 570 may have specific functions. For example, the reservoir may function as a glue melter by providing a heat source to the adhesive. The reservoir 570 may also pump the hot adhesive through conduits 572 to the dispensers 560. Also disposed along the flow path between the glue reservoir and the dispensers 560 may be the flow meter 576. The flow meter 576 may allow a preselected volume of adhesive to flow and/or may provide a confirmation whether or not the preselected amount of adhesive has moved to or through the dispensers 560.

The flow meter 576 may provide for a preselected amount of adhesive to be applied. For example a controller, such as a computer, smart device, or other processor, may direct a specific amount of adhesive to be used by directing the flow meter to allow such amount of adhesive flow. Additionally, or alternatively, with the use of a controller, comprising for non-limiting example, a computer or other processor 580, which may be in electrical communication with the flow meter 576, a closed loop feedback may be established to verify the amount of glue dispensed by sending a signal from the flow meter 576 to the controller 580. In some embodiments, the controller 580, for example a computer, smart device, or other controller may be in electrical communication with the dispensers 560 to command a preselected amount of glue to be dispensed. The electrical communication with the flow meter 576 or an actuator or controller for the flow meter may also therefore provide the closed loop feedback for verification that a desired amount of adhesive was dispensed. In the event that the controller 580 determines an incorrect adhesive amount is provided to the mattress, the user may be signaled by the controller 580 that an error has occurred, for example an incorrect amount of adhesive. The flow meter 576 may provide flow rate, adhesive volume, or both used in the adhesive process as well as other variables either on the meter or to the controller 580 or some combination thereof.

Also shown schematically adjacent to the controller 580 is a scanner 590. The scanner 590 is one illustrative embodiment which provides for optimization and improved processing of various types of mattresses which may have various type of layers. In manufacturing of mattresses, a line may be used to manufacture not only various sizes of mattresses, but various firmnesses, many of which may have differing layer materials to provide the variations in the firmness. In prior art processes, the adhesive utilized may be determined by the requirements for the highest loading between any two layers and then such adhesive may need to be used in the same density or the same surface area throughout each layer. The instant embodiments may alternatively be provided input by the scanner 590 for instance which may have a part number for the specific mattress being manufactured at that time. The part number may be linked to a lookup table or other database with specific characteristics related to mattress size, surface area, types of foams and may be stored on a storage device in electrical communication with the controller 580. Additionally, the lookup table or database may contain, or may be used to determine, the amounts of adhesive, density of adhesive, glue pump characteristics, spray pattern, speed of movement of the layers 700, 702, spacing of heads or other variables to optimize the manufacture of the mattress. Still further, in some embodiments, where multiple adhesives are available to use through the dispensers 560, a specific adhesive, or glue, type may be selected. Thus further optimizing the manufacturing process.

Further, the scanner 590 may provide information on the size of the mattress, or alternatively, the glue bridge assembly 500 may determine such. For example, a sensor may be utilized on the substrate 502 or the glue dispenser bridge 510. In some embodiments a sensor may be an optical sensor such as a laser or color determinative sensor. In other embodiments, the sensor may be a sonar type or radio frequency (RF) sensor any of which may detect an edge of the mattress, or a color change between the substrate 502 and an edge of the mattress.

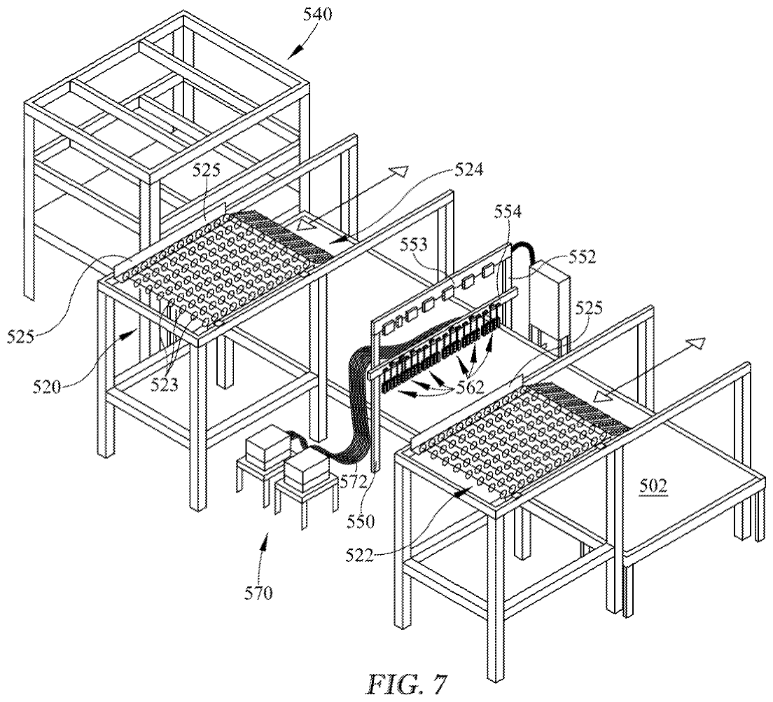

Referring now to FIG. 7, a perspective view of one embodiment of the glue bridge assembly 500 is depicted. This embodiment is a non-limited representation of the schematic view of the FIGS. 5-6 for discrete formation. The glue dispenser bridge 510 is shown extending across the substrate 502 between supports 550, 552. In this embodiment, for example, the substrate 502 is movable and defined by a belt which receives the layers 700, 702 (FIG. 5) from the at least one conveyor 520 and supports the layers during formation of a mattress.

To the left side of the substrate 502, the at least one glue reservoir 570 is shown. In this embodiment, there are two reservoirs shown which may increase capacity of a single adhesive or alternatively may provide a second adhesive capability. The reservoir may heat and pump the adhesive as previously described, to the dispensers 560. There may be a single or two or more adhesives utilized in one or more reservoirs. As will be understood, based on information for a given mattress, which will be saved and/or accessible in a database, the equipment may determine and execute adhesive type, adhesive amount delivered, surface area or other characteristics.

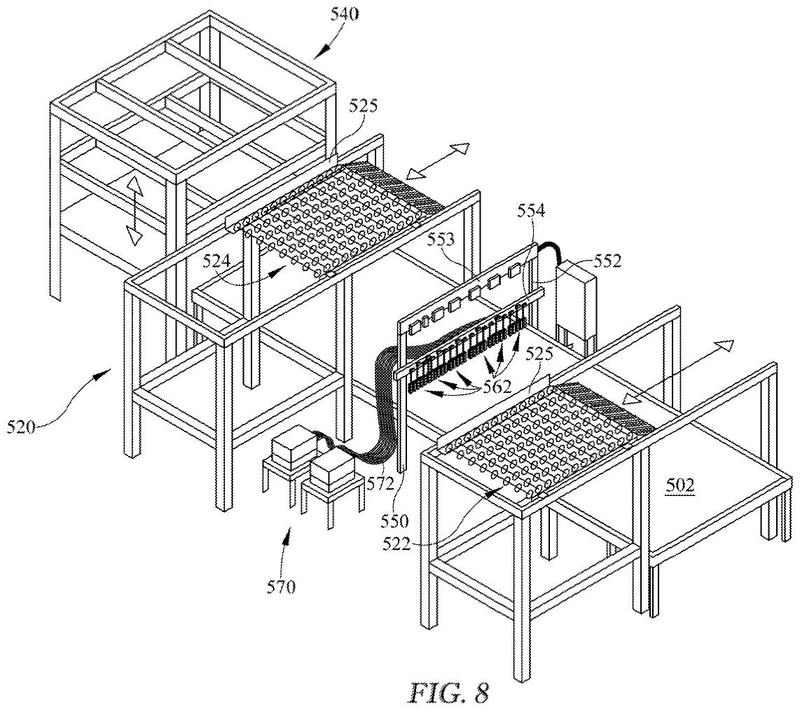

Adjacent to the substrate 502 is the at least one conveyor 520 comprising a plurality of rollers 523. The rollers 523 allow for movement of the layers 700, 702 on to the substrate 502. Additionally, a rear edge of the conveyor 520 may include a guide 525 to locate and align one edge of the layer 700, 702 thereon. Still further, the conveyor 520 is shown in one position but may be slidably moved to a second position over the substrate, as shown in FIG. 8. This allows a layer to move from the conveyor 520 on to an edge of a foam layer on the substrate 502, toward the right hand side of the substrate 502 in the depicted embodiment.

In this view, one skilled in the art will recognize that the conveyor 520 may also be used to queue multiple types of foams in the order that they will be stacked. This may be done with a single conveyor 520 as shown or may be coordinated using two or more conveyors as shown in FIG. 5.

Still further, as shown toward the rear of the substrate 502, the press 540 is disposed at an end of the substrate 502. In this position, the press 540 may receive the layers 700, 702 when the mattress is formed. The press 540 may press the laminate as each layer is added, or alternatively may be used when the laminate is completed. Further, as previously described with regard to the part number, database and/or lookup table, may also contain information related to pressure for the press 540 and/or press time needed to provide adequate fixing of the adhesive between the layers.

Referring now to FIG. 8, a similar view to that of FIG. 7 is shown. In this view, the conveyor 520 is translated from its position in the FIG. 6. The instant embodiment provides a sled 524 having the plurality of rollers shown. The sled 524 may move toward or away from the substrate 502. Further, it should be noted that the sled 524 is moved along rails or other guiding structure. Various structures may be used to move the sled 524. In the depicted position, a foam layer may be deposited on the substrate 502. In order to do this, the conveyor 520 is moved into the position shown and at the right hand side (in the depicted view) of the substrate 502, an edge of the foam layer is retained on the substrate 502 or on a lower foam layer on the substrate 502. Once the upper foam layer is retained along an edge (for example the right hand edge in the depicted view), the conveyor 520 may be translated toward the position shown in FIG. 6, leaving the upper foam layer on the lower foam layer, both on substrate 502. The foam will be aligned along two edges due to the holding of the upper foam layer in position along one edge and the guide 525 aligning the foam layers along a transverse edge.

In operation, the stack rate is expected to increase as opposed to previous methods of production, which included the manual processes. In the instant embodiment, the rate of production is expected to increase to about up to about 50 stacks and in some embodiments may be around 40 stacks per hour.

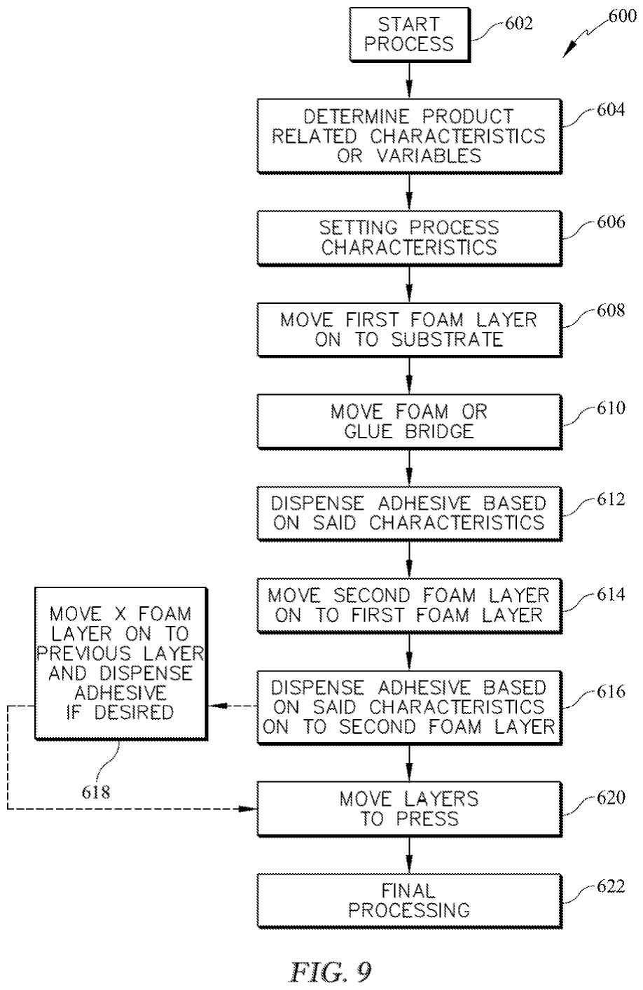

Referring now to FIG. 9, a flow chart is depicted for an illustrative method of automating a laminate stacking process 600. At the first step 602 of the process which may come in a variety of forms including, but not limited to, powering a controller such as computer 580 (FIG. 6) or a smart device, or the like, as well as powering on any powered features, such as the glue reservoir 570 (FIG. 6) and any other powered structures, for example substrate 502 (FIG. 6) and/or conveyors 520 (FIG. 5) and/or 522 (FIG. 5).

Next, the product related characteristics are determined at step 604. This may be performed in a variety of manners, including use of the scanner 590 (FIG. 6) to scan a part number along a processing flow path. Various characteristics may be determined by use of a part number or other determinable characteristic or variable. For example, the mattress size may be determined, the number of layers, the types of foam layers, the types of adhesive glue for each layer or interface of layers, the densities of adhesive per square inch necessary between interfaces of the various layers, the types of adhesives or glues if multiple types are available, patterns of the adhesive or glue spray or directing activities related to the manufacture of each individual mattress and the layers of foam defining such.

After determining the process related characteristics at step 604, the controller 580 may set process characteristics at step 606, which are determined during step 604 or which are set forth by determinations at step 604. In other words, the determination step 604 may provide certain settings needed at step 606 or may provide variables so that determinations may be made for settings at step 606.

Upon setting the process characteristics at step 606, for example by a controller, the first layer may be moved onto the substrate 502 at step 608.

Next, a first layer is moved onto the substrate 502 (FIG. 8) at step 606. The foam or glue dispenser bridge 510 (FIG. 5) may be moved either by the movement of the substrate 502 or movement of the glue dispenser bridge 510. This may occur at step 608. This rate of movement may also be determined in the characteristics reviewed at step 604.

Next, the layer may be moved and/or the glue dispenser bridge 510 may be moved relative to the foam at step 610. This movement of the foam may occur by the substrate 502 or by movement of the glue dispenser bridge 510, or a combination thereof.

Next, at step 612, the glue dispenser bridge 510 may dispense adhesive based on the characteristics that are either determined or set at step 604, 606. Such characteristics or variables may all be relevant in determining the density (grams per square inch), the surface area and/or the speed of movement of either the glue bridge or the foam layer on the substrate 502. Other characteristics may also be relevant in the dispensing of the adhesive from the glue dispenser bridge 510.

Next, at step 614, a second layer is moved onto the first layer. This may occur through the use of a second conveyor 522 or may be done with a single conveyor 520, wherein either of the embodiments the foam layers may be queued in an order in which they are to be applied.

Next at step 616, the glue dispenser bridge 510 may dispense adhesive based on the second characteristics onto the second foam layer. The characteristics may be any of the preceding as well as information related to the interface between the second foam layer and a subsequent foam layer.

Optionally, this may occur at step 618 for additional foam layers and additional layers of adhesive until the full mattress laminate is constructed or built up at step 618. Once the final layer of foam is applied, the layers or the built up laminate may be moved to a press at step 620. In some embodiments, it may be desirable to use a press after each layer and/or the final layer. After the laminate is pressed for some preselected period of time to enhance curing of the adhesive, the mattress may be finally processed at step 622. This may involve various steps or procedures, including but not limited to, trimming, application of a cover fabric and/or plastic to the mattress, any types of spray agents such as fire retardants, or the like. Additionally, the mattress may be boxed or otherwise packaged and/or any of a number of processes may occur necessary for shipping and/or handling of the mattress.

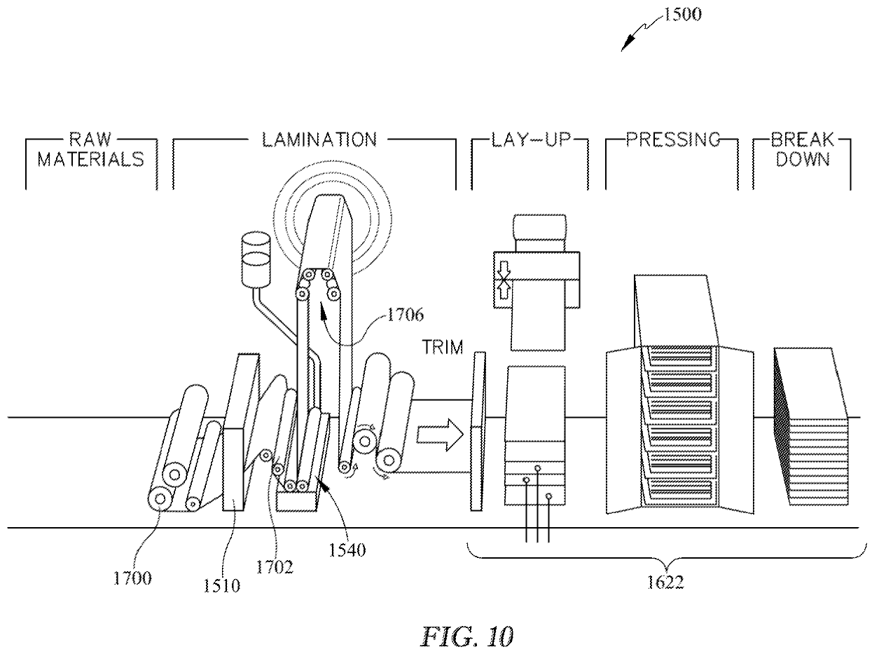

Referring now to FIG. 10, an alternative embodiment of a method of automated manufacture is provided. In the previous embodiment, discrete layers of foam are used to form the laminated mattresses. In the instant embodiment, a glue bridge assembly 1500 utilizes at least two rolls of material 1700, 1702 which are laminated in continuous form to define a mattress. The assembly includes a glue dispenser bridge 1510, which may apply adhesive to the one side of a roll 1700. At a second side of the glue dispenser bridge 1510 the first material of roll 1700, including the adhesive, is engaged by the material of second roll 1702. As the two materials of rolls 1700, 1702 are applied to one another, the laminate may pass between rollers 1540 which apply pressure and/or heat. The application of pressure and/or heat may occur at one location or may occur at different locations and/or may occur together and/or separately at multiple locations. For example, one or more heated rollers 1706 may be located downstream of the addition of roll 1702.

At one or more locations downstream of the pressure application, additional steps may occur which may be considered final processing stations 1622. For example, the laminated materials may be trimmed along one or two directions to form a desired mattress size. The mattresses may be further pressed if desirable to improve curing of adhesive. Still further, the mattresses may be broken down for application of a cover and/or plastic or boxing for subsequent handling.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teaching(s) is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A method of applying adhesive to one or more foam layers to form a laminate mattress, comprising the steps of:
conveying a first foam layer under a glue dispenser bridge;
identifying a size of said first foam layer;
determining a plurality of process characteristics for at least one of said first foam layer and at least a second foam layer;
applying a predetermined amount of glue to said first foam layer in at least one of a predetermined density or predetermined pattern;
applying a second foam layer on to said first foam layer; and,
compressing said first foam layer and said second foam layer.

2. The method of claim 1, further comprising monitoring flow meters to confirm an amount of glue applied.

3. The method of claim 2, further comprising signaling when an amount of glue applied differs substantially from said predetermined amount of said glue.

4. The method of claim 2, said monitoring being by at least one of a flow meter or software.

5. The method of claim 1 further comprising utilizing an alignment conveyor in applying said second foam substrate.

6. The method of claim 1 further comprising applying a third foam layer.

7. The method of claim 1 further comprising trimming said foam layers to a desired size.

8. The method of claim 1 further comprising moving said foam layers in at least one direction beneath said glue dispenser bridge.

9. The method of claim 1 further comprising optimizing compression time during said method.

10. The method of claim 1 further comprising optimizing cycle time for manufacture of a mattress.

11. The method of claim 1, said plurality of process characteristics including at least two of:
speed of movement of said glue dispenser bridge, speed of movement of foam layers, adhesive density, surface area of said layers, adhesive pattern, mattress size, surface area of said layers, adhesive type, compression time, and compression force.

12. A glue bridge assembly, comprising:
a first support and a second support spaced apart and configured to allow a substrate to pass therethrough;
a glue dispenser bridge extending between said supports, said glue dispenser bridge having a plurality of glue dispensers;
said plurality of glue dispensers directed downwardly to apply glue to a first foam layer which is be configured to pass below said bridge on said substrate;
a plurality of flow meters in flow communication with said plurality of glue dispensers, said flow meters creating a closed loop signal with a processor to confirm an amount of glue dispensed by said glue dispensers on said glue dispenser bridge.

13. The glue bridge assembly of claim 12 wherein said first foam layer is fed to said glue dispenser bridge in discrete form.

14. The glue bridge assembly of claim 13, further comprising a first side of said glue dispenser bridge and a second side of said glue dispenser bridge.

15. The glue bridge assembly of claim 14, further comprising a first alignment conveyor directing a first foam layer to said first side.

16. The glue bridge assembly of claim 15, further comprising a second alignment conveyor directing second foam layers to said second side.

17. The glue bridge assembly of claim 15 wherein said substrate can move said first and second layers relative to said glue bridge.

18. The glue bridge assembly of claim 12, further comprising at least one glue machine to dispense glue through said flow meters to said glue dispensers.

19. The glue bridge assembly of claim 12 further comprising a press downstream of said glue dispenser bridge.

20. The glue bridge assembly of claim 12 wherein said foam layer is fed to said glue dispenser bridge in continuous form.

21. The glue bridge assembly of claim 20 further comprising a press which is defined by at least one heated roller.

22. The glue bridge assembly of claim 19 further comprising a trim station.

23. The glue bridge assembly of claim 22 wherein said a laminate of said layers is cut in at least one direction.

24. A method of applying adhesive to one or more layers to form a laminate mattress, comprising the steps of:
conveying a first layer under a glue dispenser bridge;
identifying a size of said first layer;
determining a plurality of process characteristics for at least one of said first layer and at least a second layer;
applying a predetermined amount of glue to said first layer in at least one of a predetermined density or predetermined pattern, wherein the predetermined density or predetermined pattern is determined based on the plurality of process characteristics;
applying a second layer on to said first layer; and,
compressing said at least one first layer and said at least one second layer.
